(19) United States
(12) Patent Application Publication
(10) Pub. No.: US 2019/0106902 A1
(43) Pub. Date: Apr. 11, 2019

(54) Automatically Retractable Vehicle Cover

(71) Applicant: Francisco Irizarry, Boca Raton, FL (US)

(72) Inventor: Francisco Irizarry, Boca Raton, FL (US)

(21) Appl. No.: 16/155,625

(22) Filed: Oct. 9, 2018

Related U.S. Application Data
(60) Provisional application No. 62/568,923, filed on Oct. 6, 2017.

(51) Int. Cl. E04H 15/38; B60J 11/04; E04H 6/04

(52) U.S. Cl. CPC E04H 15/38; E04H 6/04; B60J 11/04

(57) ABSTRACT

A retractable vehicle cover includes a collapsible cover, a mounting bracket, a first powered shaft, a second powered shaft, a retractable mechanism, a control module, a monitoring module, a wireless communication module, and at least one power supply.

The collapsible cover is rotatably connected to the mounting bracket by the first powered shaft and the second powered shaft. The retractable mechanism allows the collapsible cover to automatically retract and deploy. The mounting bracket can be permanently or temporarily deployed. If temporarily deployed, a pair of wheel chocks utilizes the weight of the vehicle to secure the mounting bracket to the vehicle. The control module receives signals from the wireless communication module and accordingly controls the monitoring module. Finally, the monitoring module allows a user to remotely monitor the collapsible cover. The control module, the monitoring module, the wireless communication module are powered by the at least one power supply.

The current application claims a priority to the U.S. Provisional Patent application Ser. No. 62/568,923 filed on Oct. 6, 2017. The current application is filed on the next business day, which is Oct. 9, 2018, while Oct. 6, 2018 was on a weekend and Oct. 8, 2018 was on a national holiday (Columbus Day).

### FIELD OF THE INVENTION

The present invention generally relates to a collapsible cover for protecting a car from natural elements such as rain or the sun and capable of being deployed permanently or temporarily on a parking lot. More specifically, the collapsible cover utilizes a plurality of rotating panels to retract into a compact configuration for storage and an opened configuration to protect the vehicle from natural elements.

### BACKGROUND OF THE INVENTION

Presently, many retractable car covers are known in the prior art. Retractable car covers are usually stored in a container for storage and safe-keeping. The container is usually attached to the car itself to prevent it from getting lost or stolen. In most cases, a retraction mechanism is also provided to automatically retract and extend the cover into and out of the container. However, since the container must be connected to the car, the container cannot be wider or longer than the width or the length of the car. Accordingly, the covers are usually too small to completely enclose the car. For example, if the container is in the front top portion of the trunk, the cover dispenses out of the front of the trunk and only encloses the front two-thirds of the car. The cover is simply too small to completely enclose the sides of the car. The container therefore is a deficiency of conventional retractable car covers known in the prior art.

The present invention is retractable vehicle cover that collapses into compact configuration and remains exposed on the parking lot. Instead of using a container to secure and store the cover, the present invention utilizes a mounting bracket that permanently attaches to the ground on the parking lot. Alternately, the mounting bracket may be equipped with wheel chocks that are fixed in place by the weight of the car, thereby also securing the cover to the car.

Further, the present invention uses actuators to automatically retract and collapse the cover. Accordingly, the cover is made of a plurality of panels that folds into each other to collapse in the same manner as an accordion. The plurality of panels is connected to electrically or hydraulically actuated shafts located on each side of the mounting bracket, which rotate the cover into a collapsed or an extended configuration. The shafts may be powered by electric motors, hydraulic actuators, pneumatic actuators, any automatic mechanism. The actuators are controlled via a mobile application or using a keypad and a screen located next to the mounting bracket.

### BRIEF DESCRIPTION OF THE DRAWINGS

FIG. 1 is a top perspective view of the present invention deployed in the opened position over a vehicle.

FIG. 2 is a schematic diagram of the electronic connections of the present invention.

FIG. 3 is a schematic diagram of the electrical connections of the present invention.

FIG. 4 is a perspective view of the retractable mechanism utilizing a first electric motor.

FIG. 5 is a front perspective view of the collapsible cover transitioning into a closed position.

FIG. 6 is a front perspective view of the collapsible cover in the closed position.

FIG. 7 is an exploded view of the collapsible cover, the mounting bracket, the retractable mechanism, the first wheel chock, and the second wheel chock.

FIG. 8 is a detail view of the plurality of rotating panels showing the pin on the convex side.

FIG. 9 is a detail view of the plurality of rotating panels showing the guide track on the concave side.

FIG. 10 is an exploded view of the protection box enclosing the keypad, the NFC receiver, the PAN receiver, WLAN receiver, the GSM receiver, and the at least one power supply.

FIG. 11 is a detail view of the interior of the collapsible cover showing the interior camera and the plurality of motion sensors.

FIG. 12 is a side perspective view of the collapsible cover transitioning into a close position with the hydraulic actuator shown in broken lines.

### DETAILED DESCRIPTION OF THE INVENTION

All illustrations of the drawings are for the purpose of describing selected versions of the present invention and are not intended to limit the scope of the present invention.

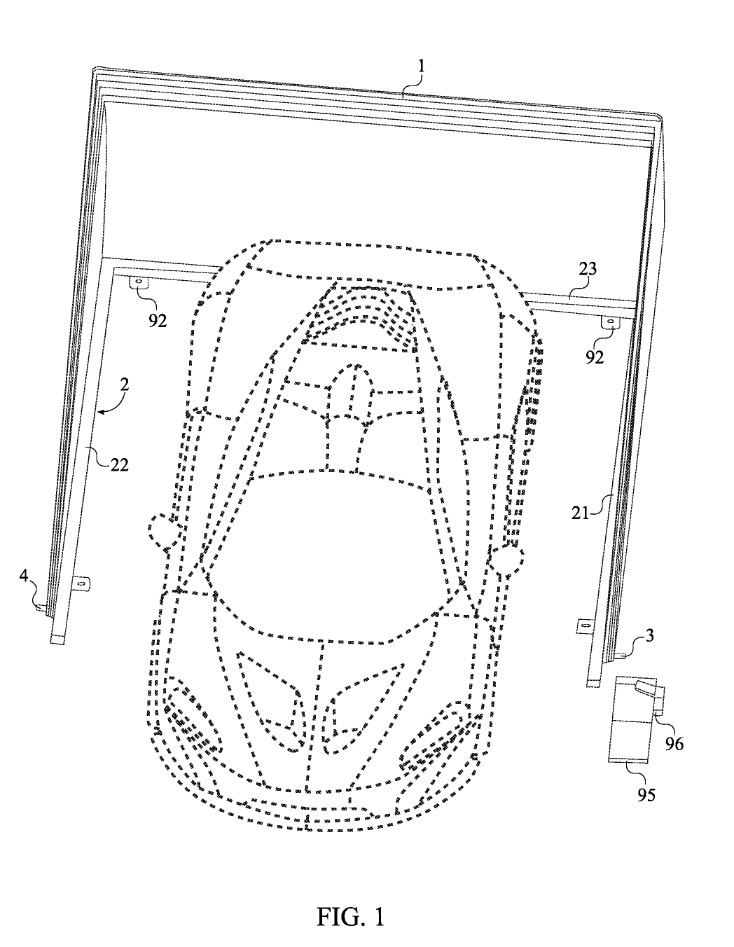

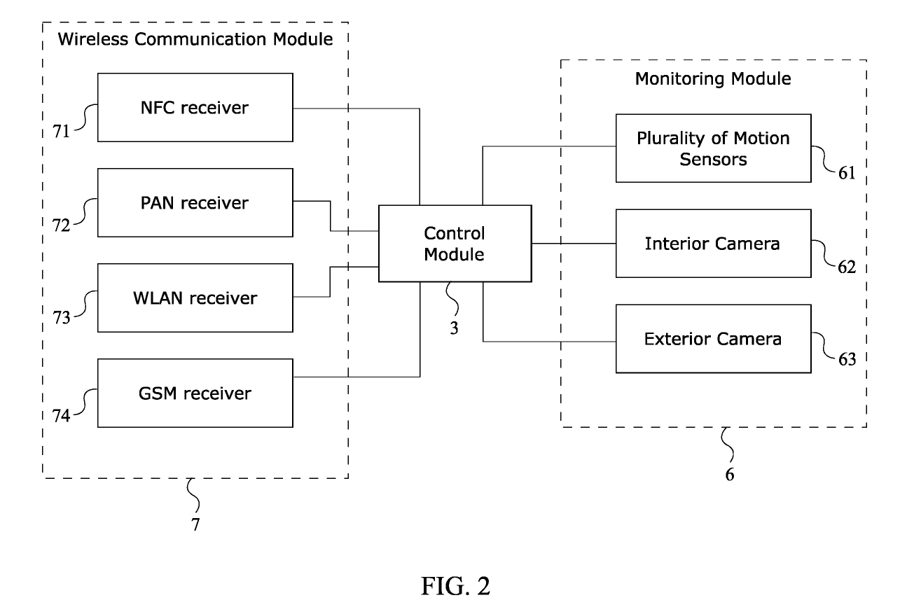

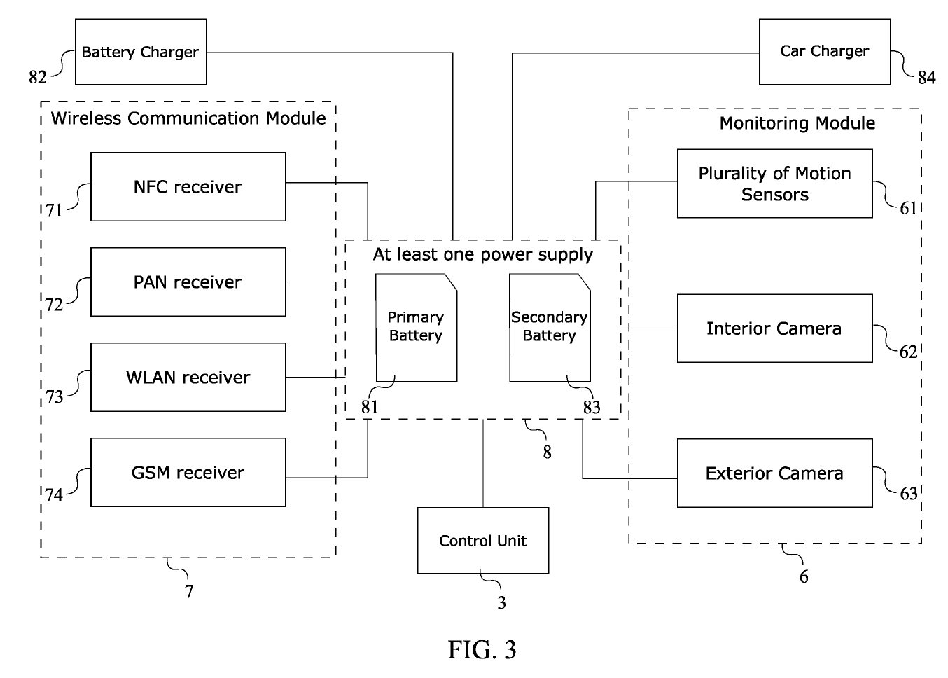

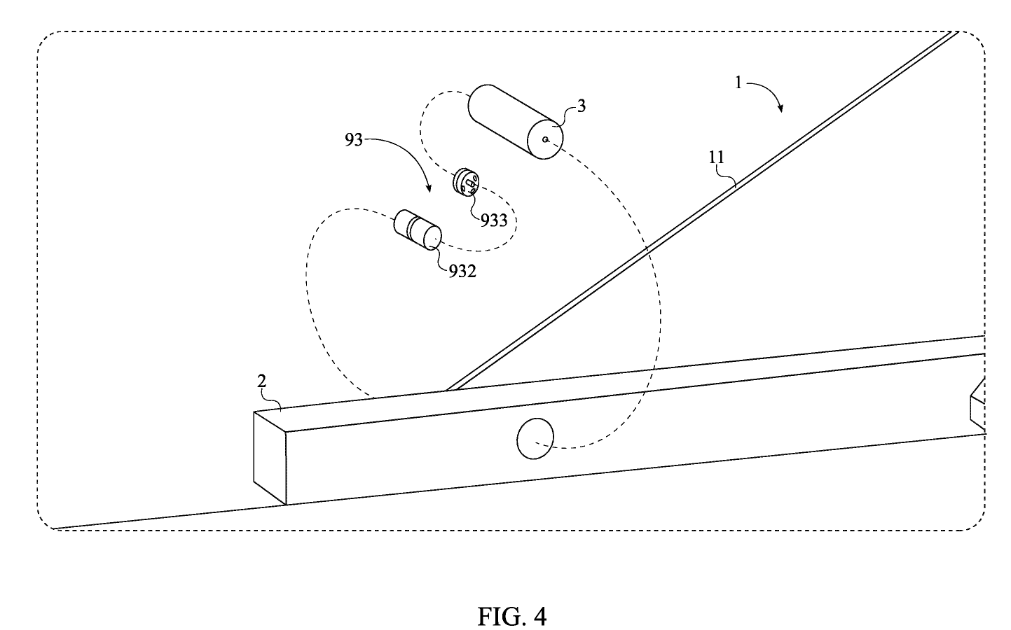

Referring to FIG. 1, FIG. 2, FIG. 3, and FIG. 4, the present invention is a retractable vehicle cover for protecting a vehicle from dust, rain, snow, hail, UV rays, theft, and/or vandalism. The preferred embodiment of the present invention comprises a collapsible cover 1, a mounting bracket 2, a first shaft 3, a second shaft 4, a retractable mechanism 93, a control module 5, a monitoring module 6, a wireless communication module 7, and at least one power supply 8. The collapsible cover 1 may be made of impact resistant plastic, aluminum, and carbon fiber for securely enclosing the vehicle. Aluminum and carbon fiber give the collapsible cover 1 rigidity whereas plastic gives the collapsible cover 1 flexibility. Preferably, the mounting bracket 2 is enclosed by the collapsible cover 1. The mounting bracket 2 is a rigid frame that surrounds the vehicle and allows the collapsible cover 1 to extend over the vehicle. The mounting bracket 2 may be permanently or temporarily deployed onto the parking lot. In one possible embodiment, the mounting bracket 2 may be directly bolted to the ground, thus permanently connecting the mounting bracket 2 onto the parking lot. In another possible embodiment, the mounting bracket 2 may be held in place by the weight of the vehicle. Once the vehicle rolls off, the mounting bracket 2 may be withdrawn from the parking lot.

Referring more specifically to FIG. 1 and FIG. 4, the first shaft 3 and the second shaft 4 allow the collapsible cover 1 to extend and retract over the mounting bracket 2 and the enclosed vehicle. As such, the collapsible cover 1 is rotatably connected to the mounting bracket 2 by the first shaft 3 and the second shaft 4. Accordingly, the first shaft 3 is laterally connected onto the mounting bracket 2. Similarly, the second shaft 4 is laterally connected onto the mounting bracket 2, opposite the first shaft 3. Preferably, both the first shaft 3 and the second shaft 4 are rotatably connected onto the mounting bracket 2. This allows the retractable mechanism 93 to effortlessly extend or retract the collapsible cover 1.

Referring more specifically to FIG. 2 and FIG. 4, the preferred retractable mechanism 93 utilizes electrical, hydraulic, or pneumatic actuators to automatically configure the collapsible cover 1 into the opened or closed position. Accordingly, the collapsible cover 1 is operatively coupled to the mounting bracket 2 by the retractable mechanism 93, wherein the collapsible cover 1 operates in between an opened position and a closed position by the retractable mechanism 93. Moreover, the retractable mechanism 93 is remotely operated via the control module 5 and the wireless communication module 7. As such, the control module 5 is electronically connected to the monitoring module 6 and the wireless communication module 7. The control module 5 may be a programmable integrated circuit (IC) that receives signals from the wireless communication module 7 and accordingly controls the monitoring module 6 and the retractable mechanism 93. The preferred wireless communication module 7 may utilize a wireless local area network (WLAN) transceiver, a short-range radio frequency (RF) transceiver, a near field communication (NFC) transceiver, and/or cellular transceiver to allow a user to remotely actuate the retractable mechanism 93. Moreover, the retractable mechanism 93 may also be controlled by data I/O devices electronically connected to the control module 5. In one possible embodiment, the control module 5 may be connected to a keypad and screen allowing a user near the present invention to operate the retractable mechanism 93.

Similarly, the monitoring module 6 may also be operated remotely or physically. The preferred monitoring module 6 may utilize interior and exterior 360° cameras and motion sensors to monitor the inside and outside the collapsible cover 1. Using the wireless communication module 7, the control module 5 may allow a user to remotely access data feed from the monitoring module 6. For example, the user may use a smartphone with a mobile application which streams video directly from the 360° cameras.

Referring more specifically to FIG. 3, the control module 5, the monitoring module 6, and the wireless communication module 7 are powered by at least one power supply 8. As such, the at least one power supply 8 is electrically connected to the control module 5, the monitoring module 6, and the wireless communication module 7. The at least one power supply 8 may include one or more rechargeable batteries that are charged by an external power source. The one or more rechargeable batteries may also be used to charge the vehicle's electrical systems.

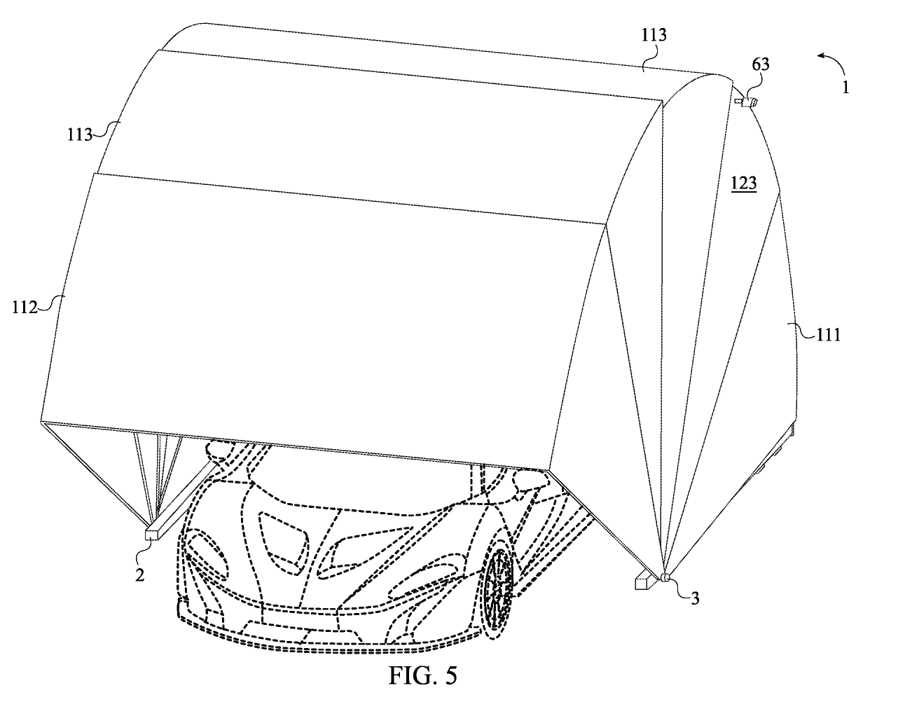

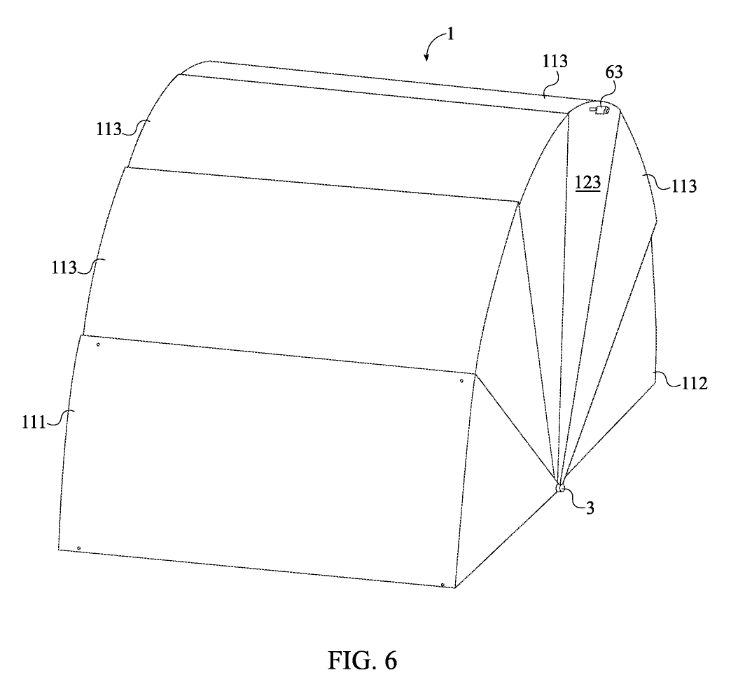

Referring to FIG. 5 and FIG. 6, in the preferred embodiment of the present invention, the collapsible cover 1 comprises a plurality of rotating panels 11. The plurality of rotating panels 11 comprises a fixed panel 111, a free panel 112, and at least one intermediary panel 113. The fixed panel 111 remains fixed to the mounting bracket 2 in both the opened and closed position, whereas the free panel 112 freely rotates about the mounting bracket 2. As such, the fixed panel 111 is connected to the mounting bracket 2. Similarly, the free panel 112 is rotatably connected to the mounting bracket 2. More specifically, the free panel 112 rotates about the first shaft 3 and the second shaft 4 by the retractable mechanism 93. Further, the at least one intermediary panel 113 is rotatably connected to the fixed panel 111. The at least one intermediary panel 113 is also linked to free panel 112. Thus, as the free panel 112 rotates, the at least one intermediary panel 113 is pulled along with the free panel 112. In the closed position, the fixed panel 111 and the at least one intermediary panel 113 collapse into the free panel 112. As such, the at least one intermediary panel 113 is rotatably connected to the free panel 112, opposite of the fixed panel 111. Further, the at least one intermediary panel 113 is positioned between the fixed panel 111 and the free panel 112. As such, the at least one intermediary panel 113 makes up the majority of the surface area of the collapsible cover 1.

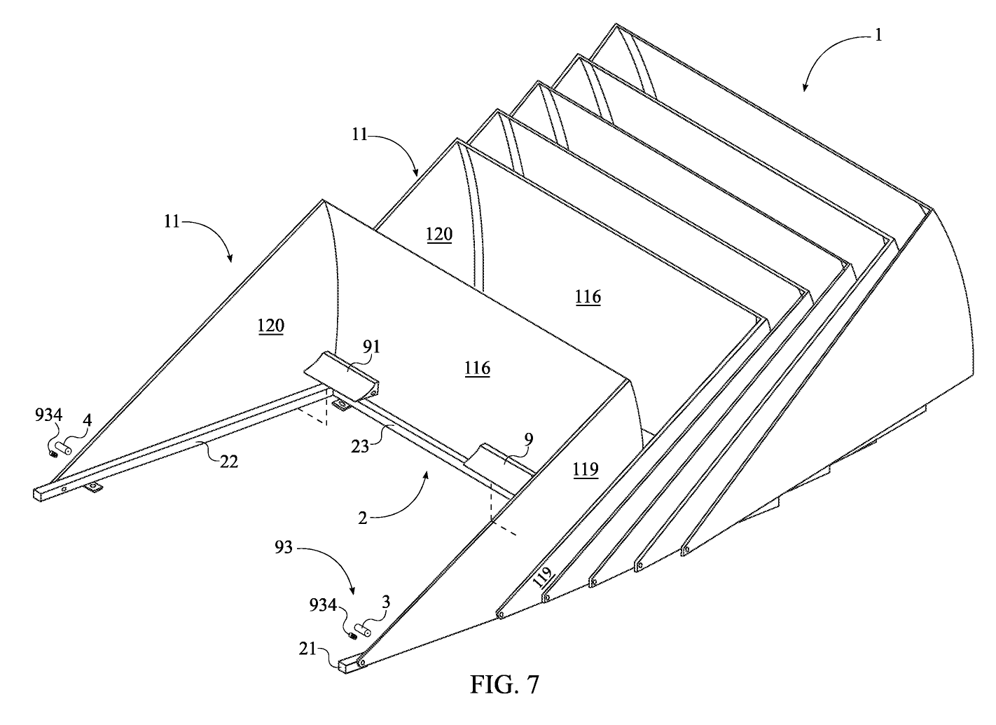

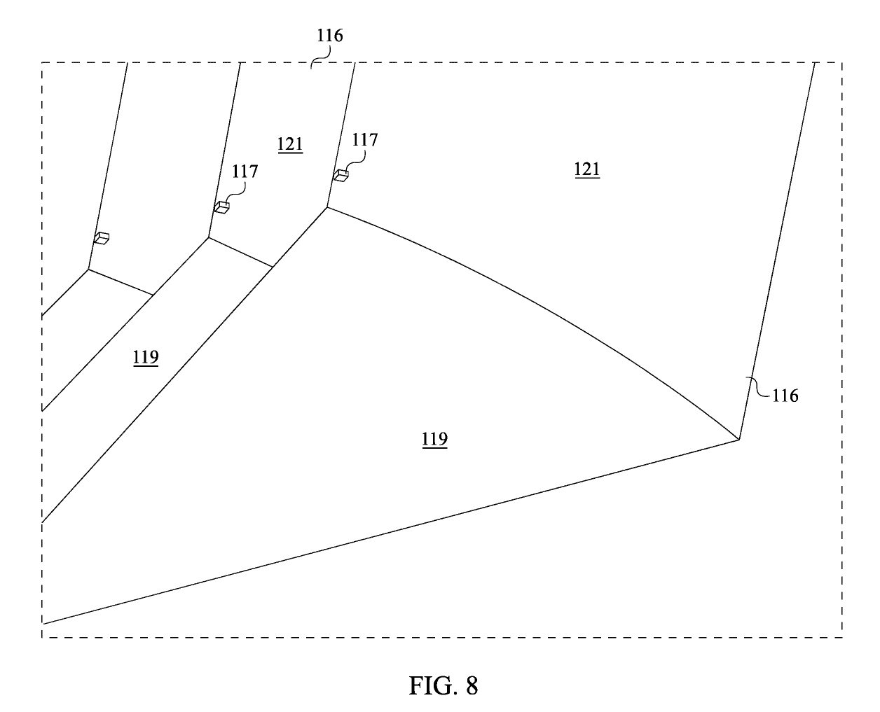

Referring to FIG. 7 and FIG. 8, further, each of the plurality of rotating panels 11 comprises a curved panel 116, a first end section 119, and a second end section 120. The curved panel 116 gives the collapsible cover 1 a semi-circular shape in the closed position, thereby maximizing the internal volume of the collapsible cover 1. The first end section 119 and the second end section 120 are connected opposite each other about the curved panel 116. Unlike the curved panel 116, the first end section 119 and the second end section 120 are substantially flat. However, both the first end section 119 and the second end section 120 have a curved edge that connects onto the curved panel 116. Preferably, the first end section 119 and the second end section 120 correspond to opposite sides of the rotating panel. Thus, the first end section 119 and the second end section 120 are attached to the opposite sides of the mounting bracket 2. Further, the first end section 119 is connected onto the first shaft 3. Similarly, the second end section 120 is connected onto the second shaft 4. More specifically, the first shaft 3 inserts into an insertion slot of the first end section 119. Similarly, the second shaft 4 inserts into an insertion slot of the section end section. The first shaft 3 and the second shaft 4 are rotatably connected to the corresponding insertion slot, thereby allowing the plurality of rotating panels 11 to rotate about the mounting bracket 2 without the separating.

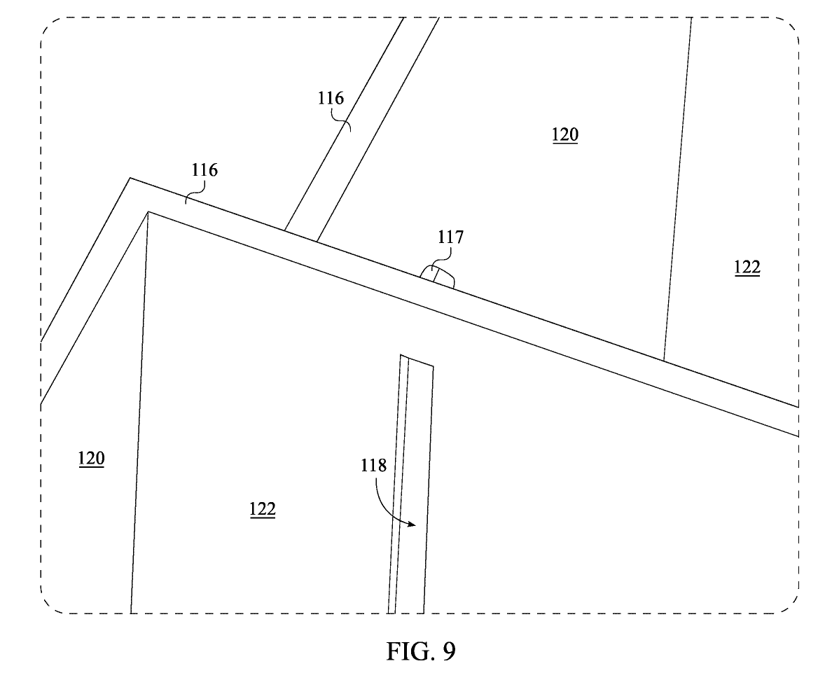

Referring to FIG. 8 and FIG. 9, in the preferred embodiment, the plurality of rotating panels 11 is mechanically linked to each other. As such, each of the plurality of rotating panels 11 further comprises a pair of pins 117 and a pair of guide tracks 118. Accordingly, the pair of guide tracks 118 traverses into a concave side 122 of the curved panel 116. Alternately, the pair of pins 117 is connected onto a convex side 121 of the curved panel 116. In the preferred embodiment, each curved panel 116 is positioned with the concave side 122 facing towards the convex side 121 of an adjoining curved panel 116. In the closed position, the concave side 122 of each curved panel 116 is positioned directly over the convex side 121 of the adjoining curved panel 116. As such, the pair or pins of each curved panel 116 is slidably engaged to the pair of guide tracks 118 of a corresponding curved panel 116. The slidable engagement between the pair of pins 117 and the pair of guide tracks 118 ensures that the at least one intermediary panel 113 follows the free panel 112 as the free panel 112 starts rotating about the mounting bracket 2.

Referring to FIG. 4 and FIG. 7, preferably, the movement of the free panel 112 is controlled by the retractable mechanism 93. The preferred embodiment of the retractable mechanism 93 comprises a first electric motor 931 and a second electric motor 934. The first electric motor 931 preferably drives the first shaft 3 and the second electric motor 934 drives the second shaft 4. More specifically, a stator 932 of the first electric motor 931 is connected to the mounting bracket 2. Similarly, a rotor 933 of the first electric motor 931 is engaged to the first shaft 3. As such, the first electric motor 931 uses the mounting bracket 2 as a support to help rotate the first shaft 3. Similarly, a stator 932 of the second electric motor 934 is connected to the mounting bracket 2. In this case, a rotor 933 of the second electric motor 934 is connected to the second shaft 4. Thus, the rotor 933 can rotate freely about the stator 932. Preferably, both the first electric motor 931 and the second electric motor 934 are powered by the at least one power supply 8. Accordingly, the first electric motor 931 is electrically connected to the at least one power supply 8. Further, the second electric motor 934 is electrically connected to the at least one power supply 8.

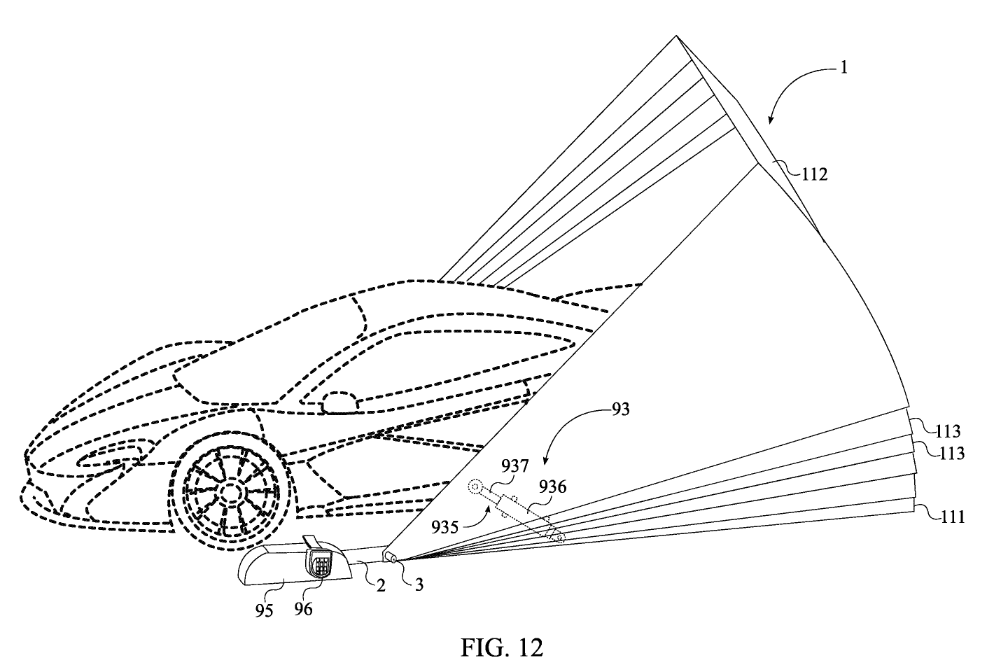

Referring to FIG. 12, in an alternate embodiment, the retractable mechanism 93 comprises a hydraulic actuator 935. A cylinder 936 of the hydraulic actuator 935 is connected to the mounting bracket 2. The cylinder 936 of the hydraulic actuator 935 is positioned adjacent to the first shaft 3. Further, a piston 937 of the hydraulic actuator 935 is connected to a free panel 112 of the plurality of rotating panels 11. As such, the cylinder 936 of the hydraulic actuator 935 remains fixed to the mounting bracket 2 whereas the piston 937 freely moves along with the free panel 112.

In yet another embodiment, the hydraulic actuator 935 may be positioned on the opposite side of the mounting bracket 2. In this embodiment, the cylinder 936 of the hydraulic actuator 935 is still connected to the mounting bracket. However, the cylinder 936 of the hydraulic actuator 935 is positioned adjacent to the second shaft. As such, the piston 937 of the hydraulic actuator 935 is connected to the free panel of the plurality of rotating panels 11.

Referring more specifically to FIG. 1, the preferred embodiment of the mounting bracket 2 comprises a first parallel member 21, a second parallel member 22, and a cross member 23. The first parallel member 21, the second parallel member 22, and the cross member 23 are arranged in a U-shaped formation that surrounds the parking space and the vehicle. As such, the first parallel member 21 is connected adjacent to the cross member 23. Further, the second parallel member 22 is connected adjacent to the cross member 23, opposite the first parallel member 21. The first parallel member 21 and the second parallel member 22 may further comprise a plurality of slots that allow first shaft 3 and the second shaft 4 to connect. Alternately, the mounting bracket 2 may be any shape or size as required to successfully enclose the vehicle.

Referring back to FIG. 7, the mounting bracket 2 may be permanently or temporarily deployed on the parking lot as seen fit. As such, a first wheel chock 9 and a second wheel chock 91 allow the mounting bracket 2 to be temporarily deployed on the parking lot. The first wheel chock 9 and the second wheel chock 91 are connected to the mounting bracket 2. More specifically, the first wheel chock 9 is connected to the first parallel member 21. Similarly, the second wheel chock 91 is connected to the second parallel member 22. In the preferred embodiment, the first wheel chock 9 and the second wheel chock 91 are each pressed against to a wheel of the vehicle. Accordingly, the weight of the vehicle pressing down on the first wheel chock 9 and the second wheel chock 91 prevents the mounting bracket 2 from separating from the vehicle.

Referring back to FIG. 1, in another embodiment, the mounting bracket 2 may be permanently deployed on the parking lot. Accordingly, a plurality of mounting tabs 92 is provided which permanently affixes the mounting bracket 2 to the ground. Each mounting tab 92 comprises a hole that allows each mounting tab 92 to be permanently bolted onto the ground. This permanently affixes the mounting bracket 2 to the ground. Accordingly, the plurality of mounting tabs 92 is connected adjacent to the mounting bracket 2. Additionally, the plurality of mounting tabs 92 may be folded against the mounting bracket 2 when not in use. This also makes it easier to store the mounting bracket 2 when not in use. Preferably, the plurality of mounting tabs 92 is perimetrically positioned along the mounting bracket 2. Further, the plurality of mounting tabs 92 is positioned facing towards the vehicle. This creates a more secure connection between the mounting bracket 2 and the ground.

Referring to FIG. 2 and FIG. 3, the wireless communication module 7 comprises a near field communication (NFC) receiver 71, a personal area network (PAN) receiver 72, a wireless local area network (WLAN) receiver 73, and a global system for mobile (GSM) receiver 74. The NFC receiver 71, the PAN receiver 72, the WLAN receiver 73, the GSM receiver 74 are all electronically connected to the control module 5. In the preferred embodiment, the NFC receiver 71 and the PAN receiver 72 are used for short-range communication with the control module 5. Further, both the NFC receiver 71 and PAN receiver 72 can be used to lock the collapsible cover 1 in the closed position. For example, users can simply touch their smartphone to the NFC receiver 71. Similarly, the PAN receiver 72 may be used once the user is in close range of the collapsible cover 1. Alternately, the GSM receiver 74 and the WLAN receiver 73 are more suited for long distance communication, and thus allow the user to remotely operate the control module 5. For example, the GSM receiver 74 allows the user to use a mobile application to communicate with the control module 5. The mobile application may also help the user save and locate the vehicle and parking spot on a map displayed on the smartphone.

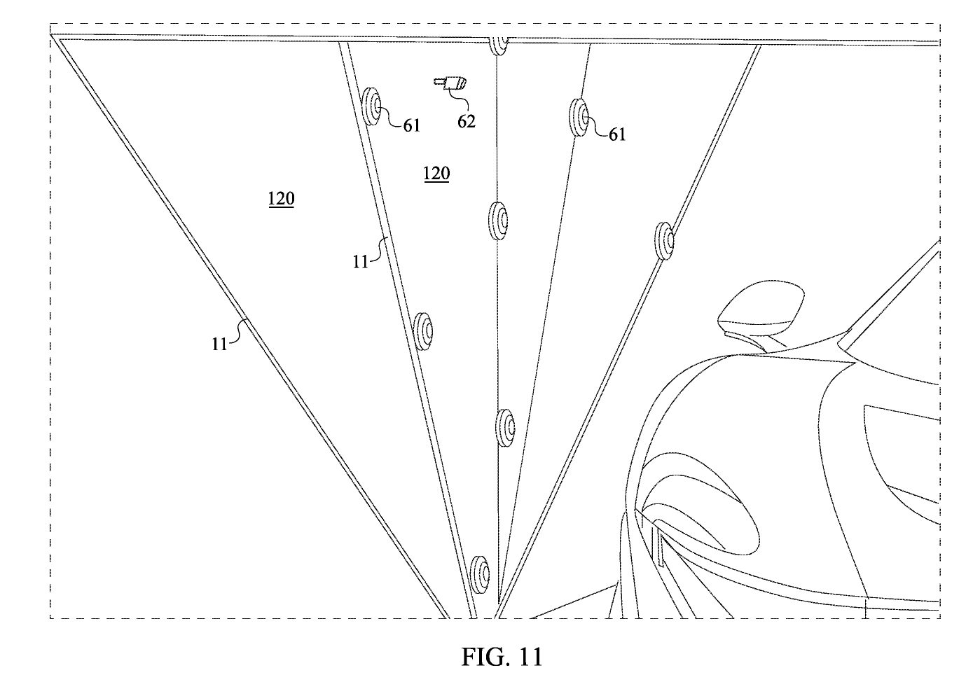

Referring to FIG. 5 and FIG. 11, the mobile application may also be used to stream data from the monitoring module 6. The preferred monitoring module 6 is designed to monitor both the exterior and the interior of the collapsible cover 1. As such the monitoring module 6 comprises a plurality of motion sensors 61, an interior camera 62, and an exterior camera 63. The plurality of motion sensors 61 is mounted inside the collapsible cover 1 to monitor the vehicle inside the collapsible cover 1. Similarly, the interior camera 62 is also mounted inside the collapsible cover 1. In contrast, the exterior camera 63 is mounted to an exterior face 123 of the collapsible cover 1 to monitor the immediate vicinity of the collapsible cover 1. The preferred interior camera 62 and the exterior camera 63 are 360° cameras that can record surround view videos. The video data along with the data from the motion sensors 61 are streamed to the user's smartphone via the wireless communication module 7. The data may be streamed continuously or stored in internal memory by the control module 5 for future record.

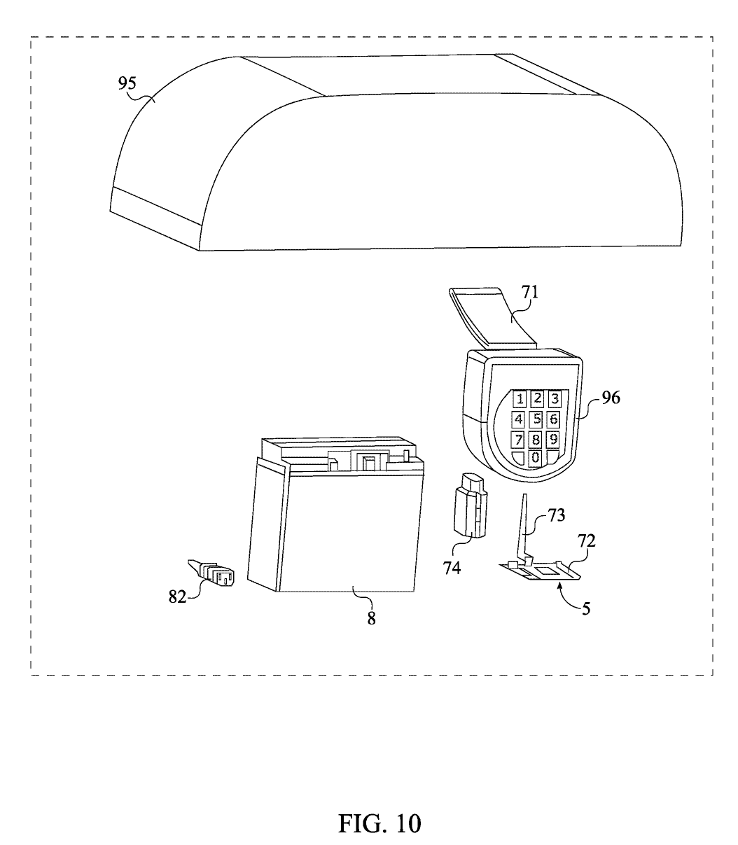

Referring to FIG. 1 and FIG. 10, in the preferred embodiment, a protection box 95 is provided to protect the control module 5, the wireless communication module 7, and the monitoring module 6. Further, a keypad 96 is also provided to allow the user to physically control the retractable mechanism 93, in case the wireless communication module 7 malfunctions. The at least one power supply 8, the control module 5, the wireless communication module 7, and the monitoring module 6 are mounted within the protection box 95. The protection box 95 is a large metallic enclosure that protects the enclosed components for environmental elements, theft, or vandalism. The protection box 95 may be affixed to the first shaft 3 or the second shaft 4 to prevent separation from the mounting bracket 2. Alternately, the protection box 95 may be bolted onto the ground or may weighed down by ballast. By positioning the protection box 95 outside the collapsible cover 1, the user has access to the keypad 96. As such, the keypad 96 is laterally mounted onto the protection box 95. Further, the keypad 96 is electronically connected to the control module 5. Once the user enter the correct key, the control module 5 is programmed to activate the retractable mechanism 93 and opened the collapsible cover 1.

Referring to FIG. 3, finally, the at least one power supply 8 comprises a primary battery 81 and a battery charger 82. The primary battery 81 supplies electricity to all of the electrically operated components. As such, the primary battery 81 is electrically connected to the control module 5, the monitoring module 6, and the wireless communication module 7. The battery charger 82 charges the primary battery 81 using an external power source. The battery charger 82 is electrically connected to the primary battery 81.

Further, the at least one power supply 8 may also utilize a backup power supply. As such, the at least one power supply 8 further comprises a secondary battery 83 and a car charger 84. The at least one power supply 8 is electrically connected to the secondary battery 83. Further, the car charger 84 is electrically connected to the secondary battery 83. The car charger 84 can be used to recharge the electrical systems of the vehicle with the secondary battery 83. Alternately, the car charger 84 may also be electrically connected to the primary battery 81. As such, this allows the car charger 84 to charge the electrical systems of the vehicle using both the primary battery 81 and the secondary battery 83.

Although the invention has been explained in relation to its preferred embodiment, it is to be understood that many other possible modifications and variations can be made without departing from the spirit and scope of the invention as hereinafter claimed.

What is claimed is:

1. An automatically retractable vehicle cover comprises:
a collapsible cover;
a mounting bracket;
a first shaft;
a second shaft;
a retractable mechanism;
a control module;
a monitoring module;
a wireless communication module;
at least one power supply;
the mounting bracket being enclosed by the collapsible cover;
the collapsible cover being rotatably connected to the mounting bracket by the first shaft and the second shaft;
the first shaft being laterally connected onto the mounting bracket;
the second shaft being laterally connected onto the mounting bracket, opposite the first shaft;
the collapsible cover being operatively coupled to the mounting bracket by the retractable mechanism, wherein the collapsible cover operates in between an opened position and a closed position by the retractable mechanism;
the control module being electronically connected to the monitoring module and the wireless communication module; and
the at least one power supply being electrically connected to the control module, the monitoring module, and the wireless communication module.

2. The automatically retractable vehicle cover as claimed in claim 1 comprises:
the collapsible cover comprises a plurality of rotating panels;
the plurality of rotating panels comprises a fixed panel, a free panel, and at least one intermediary panel;
the fixed panel being connected to the mounting bracket;
the free panel being rotatably connected to the mounting bracket;
the at least one intermediary panel being rotatably connected to the fixed panel;
the at least one intermediary panel being rotatably connected to the free panel, opposite of the fixed panel; and
the at least one intermediary panel being positioned between the fixed panel and the free panel.

3. The automatically retractable vehicle cover as claimed in claim 1 comprises:
the collapsible cover comprises a plurality of rotating panels;
each of the plurality of rotating panels comprises a curved panel, a first end section, a second end section;
the first end section and the second end section being connected opposite each other about the curved panel;
the first end section being connected onto the first shaft; and
the second end section being connected onto the second shaft.

4. The automatically retractable vehicle cover as claimed in claim 3 comprises:
each of the plurality of rotating panels further comprises a pair of pins and a pair of guide tracks;
the pair of guide tracks traversing into a concave side of the curved panel;
the pair of pins being connected onto a convex side of the curved panel; and
the pair of pins of each curved panel being slidably engaged to the pair of guide tracks of a corresponding curved panel.

5. The automatically retractable vehicle cover as claimed in claim 1 comprises:
the retractable mechanism comprises a first electric motor and a second electric motor;
a stator of the first electric motor being connected to the mounting bracket;
a rotor of the first electric motor being engaged to the first shaft;
the first electric motor being electrically connected to the at least one power supply;
a stator of the second electric motor being connected to the mounting bracket;
a rotor of the second electric motor being engaged to the second shaft; and
the second electric motor being electrically connected to the at least one power supply.

6. The automatically retractable vehicle cover as claimed in claim 1 comprises:
the retractable mechanism comprises a hydraulic actuator;
a cylinder of the hydraulic actuator being connected to the mounting bracket;
the cylinder of the hydraulic actuator being positioned adjacent to the first shaft: and
a piston of the hydraulic actuator being connected to a free panel of the plurality of rotating panels.

7. The automatically retractable vehicle cover as claimed in claim 1 comprises:
the retractable mechanism comprises a hydraulic actuator;
a cylinder of the hydraulic actuator being connected to the mounting bracket;
the cylinder of the hydraulic actuator being positioned adjacent to the second shaft: and
a piston of the hydraulic actuator being connected to a free panel of the plurality of rotating panels.

8. The automatically retractable vehicle cover as claimed in claim 1 comprises:
the mounting bracket comprises a first parallel member, a second parallel member, and a cross member;
the first parallel member being connected adjacent to the cross member; and
the second parallel member being connected adjacent to the cross member, opposite the first parallel member.

9. The automatically retractable vehicle cover as claimed in claim 8 comprises:
a first wheel chock;
a second wheel chock;
the first wheel chock being connected adjacent to the first parallel member; and
the second wheel chock being connected adjacent to the second parallel member.

10. The automatically retractable vehicle cover as claimed in claim 1 comprises:
a plurality of mounting tabs;
the plurality of mounting tabs being connected adjacent to the mounting bracket; and
the plurality of mounting tabs being perimetrically positioned along the mounting bracket.

11. The automatically retractable vehicle cover as claimed in claim 1 comprises:
the wireless communication module comprises a near field communication (NFC) receiver, a personal area network (PAN) receiver, a wireless local area network (WLAN) receiver, and a global system for mobile (GSM) receiver; and
the NFC receiver, the WLAN receiver, the PAN receiver, the GSM receiver being electronically connected to the control module.

12. The automatically retractable vehicle cover as claimed in claim 1 comprises:
the monitoring module comprises a plurality of motion sensors, an interior camera, and an exterior camera;
the plurality of motion sensors being mounted inside the collapsible cover;
the interior camera being mounted inside the collapsible cover; and
the exterior camera being mounted to an exterior face of the collapsible cover.

13. The automatically retractable vehicle cover as claimed in claim 1 comprises:
a protection box;
a keypad;
the at least one power supply, the control module, the wireless communication module, and the monitoring module being mounted within the protection box;
the keypad being laterally mounted onto the protection box; and
the keypad being electronically connected to the control module.

14. The automatically retractable vehicle cover as claimed in claim 1 comprises:
the at least one power supply comprises a primary battery and a battery charger,
the primary battery being electrically connected to the control module, the monitoring module, and the wireless communication module; and
the battery charger being electrically connected to the primary battery.

15. The automatically retractable vehicle cover as claimed in claim 14 comprises:
the at least one power supply further comprises a secondary battery and a car charger;
the at least one power supply being electrically connected to the secondary battery; and
the car charger being electrically connected to the secondary battery.
